(19) United States
(12) Patent Application Publication
(10) Pub. No.: US 2017/0199561 A1
(43) Pub. Date: Jul. 13, 2017

(54) ALWAYS ON DATA OVER AUDIO

(71) Applicant: AVI KEREN, RAANANA (IL)

(72) Inventor: AVI KEREN, RAANANA (IL)

(73) Assignee: DSP GROUP LTD., Herzeliya (IL)

(21) Appl. No.: 15/368,684

(22) Filed: Dec. 5, 2016

Related U.S. Application Data
(60) Provisional application No. 62/263,814, filed on Dec. 7, 2015.

(51) Int. Cl. G06F 1/32; G10L 15/22

(52) U.S. Cl. CPC G06F 1/3243; G10L 15/22; G06F 1/3215; G10L 2015/223

(57) ABSTRACT

A method for sonic acoustic beacon processing. The method may include constantly operating a microphone and a chip, even when an application processor is asleep; receiving by the microphone, while the application processor is asleep, an acoustic beacon; converting by the acoustic beacon to electrical signals representative of the acoustic beacon; receiving by the chip the electrical signals representative of the acoustic beacon; searching, by the chip and in the electrical signals representative of the acoustic beacon for a predefined preamble; when detecting the predefined preamble then decoding, by the chip, electrical signals representative of a rest of the acoustic beacon to provide digital data, and determining by the chip whether to awake the application processor; when determining to awake the application processor then participating, by the chip, in an awakening of the application processor; and sending, by the chip, the digital data to the application processor, after the awakening of the application processor.

### CROSS REFERENCE

This application claims priority from U.S. provisional patent 62/263,814 filing date Dec. 7, 2015, which is incorporated herein by reference.

### BACKGROUND OF THE INVENTION

There is a growing need to provide an “Always on” device that consumes very little amount of power in order to save battery life while being able to continuously listen to a voice trigger, detect a predefined voice phrase, decode data conveyed over an acoustic beacon and then wake up the device.

### SUMMARY

There may be provided a method for sonic acoustic beacon processing, the method may include constantly operating a microphone and a chip, even when an application processor may be asleep; receiving by the microphone, while the application processor may be asleep, an acoustic beacon; converting by the acoustic beacon to electrical signals representative of the acoustic beacon; receiving by the chip the electrical signals representative of the acoustic beacon; searching, by the chip and in the electrical signals representative of the acoustic beacon for a predefined preamble; when detecting the predefined preamble then decoding, by the chip, electrical signals representative of a rest of the acoustic beacon to provide digital data, and determining by the chip whether to awake the application processor; when determining to awake the application processor then participating, by the chip, in an awakening of the application processor; and sending, by the chip, the digital data to the application processor, after the awakening of the application processor.

The method may include constantly monitoring by the chip for the electrical signals that are representative of the acoustic beacon.

The method may include determining to awake the application processor based on the digital data.

The digital data may include filtering information and additional content; wherein the method may include determining to awake the application processor and to send the additional content to the application processor when the filtering information may be of a first value and when detecting the predefine preamble.

The additional content may be an application activation code or a universally unique identifier.

The digital data may include filtering information and additional content; wherein the method may include determining to awake the application processor and to send the additional content to the application processor when the filtering information may be of a second value, when detecting the predefine preamble and when the additional content may be of a predefined value.

The additional content may be an application activation code or a universally unique identifier.

The digital data may include filtering information and additional content; wherein the method may include determining to awake the application processor and to send the additional content to the application processor when the filtering information may be of a third value, when detecting the predefine preamble and when the additional content may be within a predefined range of values.

The additional content may be an application activation code or a universally unique identifier.

The digital data may include filtering information and additional content; wherein the additional content may include (a) an application identifier that identifies an application to be executed by the application processor, and (b) at least one application data unit to be processed by the application processor when the application processor executes the application; wherein the method may include determining to awake the application processor and to send the additional content to the application processor in response to a value of the filtering information.

The at least one application data unit may include coupon appearance information and a coupon identifier.

The method may include sending, to a computer and by a device that may include the chip and the application processor, the digital data; and receiving from the computer a response to the digital data.

The method may include determining by at least one of the chip and the application processor whether the acoustic beacon may be associated with a predefined application; transmitting at least a part of the digital data to a computer when the acoustic beacon may be associated with the predefined application; receiving from the computer coupon information and presenting to a user of the device the coupon information.

The method may include ignoring the acoustic beacon when determining that the acoustic beacon may be not associated with the predefined application.

The method may include converting the acoustic beacon when the acoustic beacon may be within a human audible acoustic range.

The method may include converting the acoustic beacon when the acoustic beacon may be outside a human audible acoustic range.

The method may include determining by at least one of the chip and the application processor whether the acoustic beacon may be associated with a predefined application; and performing, by a device that may include the chip and the application processor, at least one operation out of performing a payment, presenting information to a user of the device, presenting services to the user, performing an automatic execution of the predefined and sending a message to a sender of the acoustic beacon.

The digital data may include at least one out of a message, contact information, a store promotion, an advertisement, a coupon, a password, a Uniform Resource Locator, indoor navigation metadata and location metadata.

There may be provided a device for sonic acoustic beacon processing, the device may include a microphone, a chip and an application processor; wherein the microphone may be configured to (a) receive, while the application processor may be asleep, an acoustic beacon and (b) convert the acoustic beacon to electrical signals representative of the acoustic beacon; wherein the chip may be configured to receive the electrical signals representative of the acoustic beacon and to search for a predefined preamble; wherein when detecting the predefined preamble the chip may be configured to (i) decode electrical signals representative of a rest of the acoustic beacon to provide digital data; and (ii) determine whether to awake the application processor; and wherein when determining to awake the application processor the chip may be configured to participate in an awakening of the application processor and to send the digital data to the application processor, after the awakening of the application processor.

The device may include a power supply that may be configured to constantly power the microphone and the chip even when the application processor may be asleep.

There may be provided a computer program product that stores instructions that once executed by a device that comprises a microphone, a chip and an application processor causes the device to perform the steps of constantly operating a microphone and a chip, even when an application processor is asleep; receiving by the microphone, while the application processor is asleep, an acoustic beacon; converting by the acoustic beacon to electrical signals representative of the acoustic beacon; receiving by the chip the electrical signals representative of the acoustic beacon; searching, by the chip and in the electrical signals representative of the acoustic beacon for a predefined preamble; when detecting the predefined preamble then decoding, by the chip, electrical signals representative of a rest of the acoustic beacon to provide digital data, and determining by the chip whether to awake the application processor; when determining to awake the application processor then participating, by the chip, in an awakening of the application processor; and sending, by the chip, the digital data to the application processor, after the awakening of the application processor. The computer program product may include one or more non-transitory computer readable media.

### BRIEF DESCRIPTION OF THE INVENTION

The present invention will be understood and appreciated more fully from the following detailed description taken in conjunction with the drawings in which:

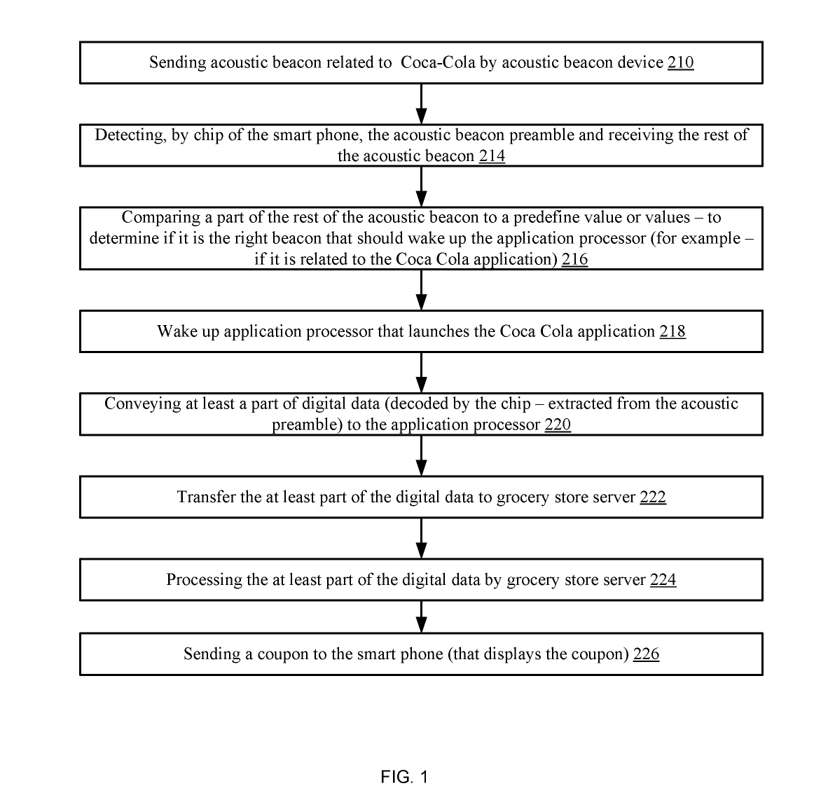

FIG. 1 is an example of a method;

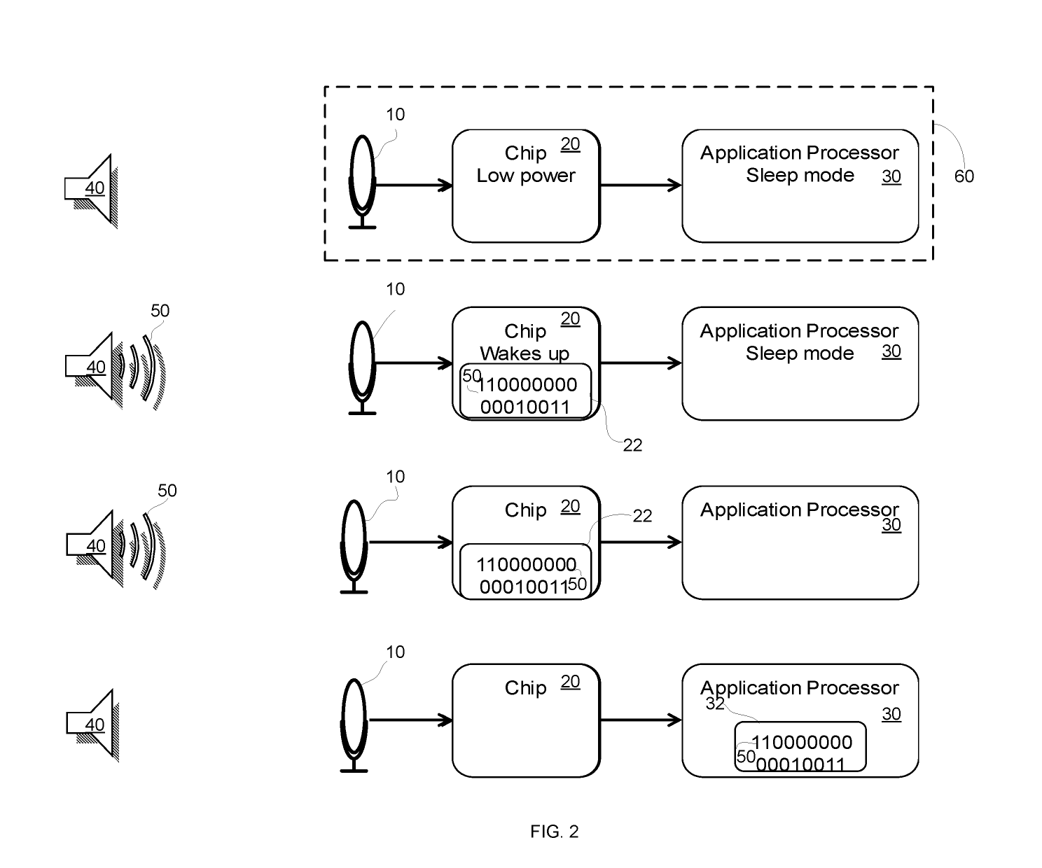

FIG. 2 provides examples of various scenarios related to a device;

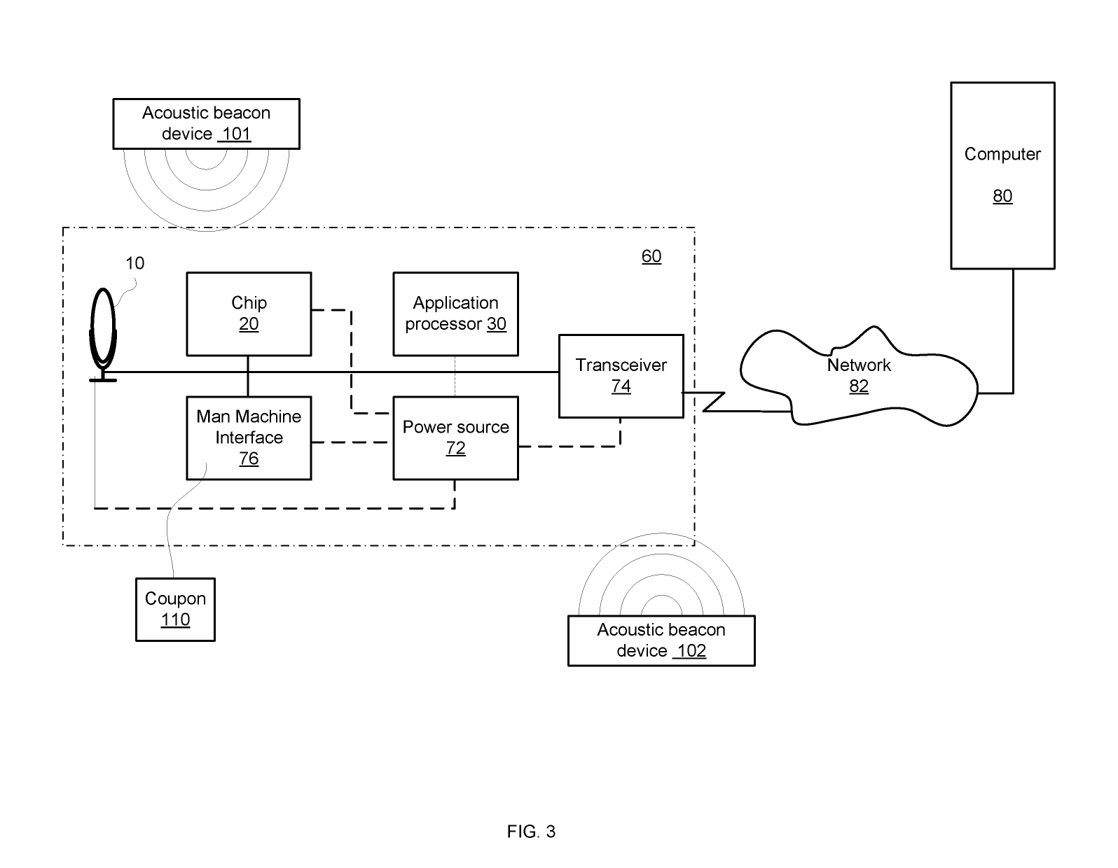

FIG. 3 is an example of a device, a network, a computer and acoustic beacon devices;

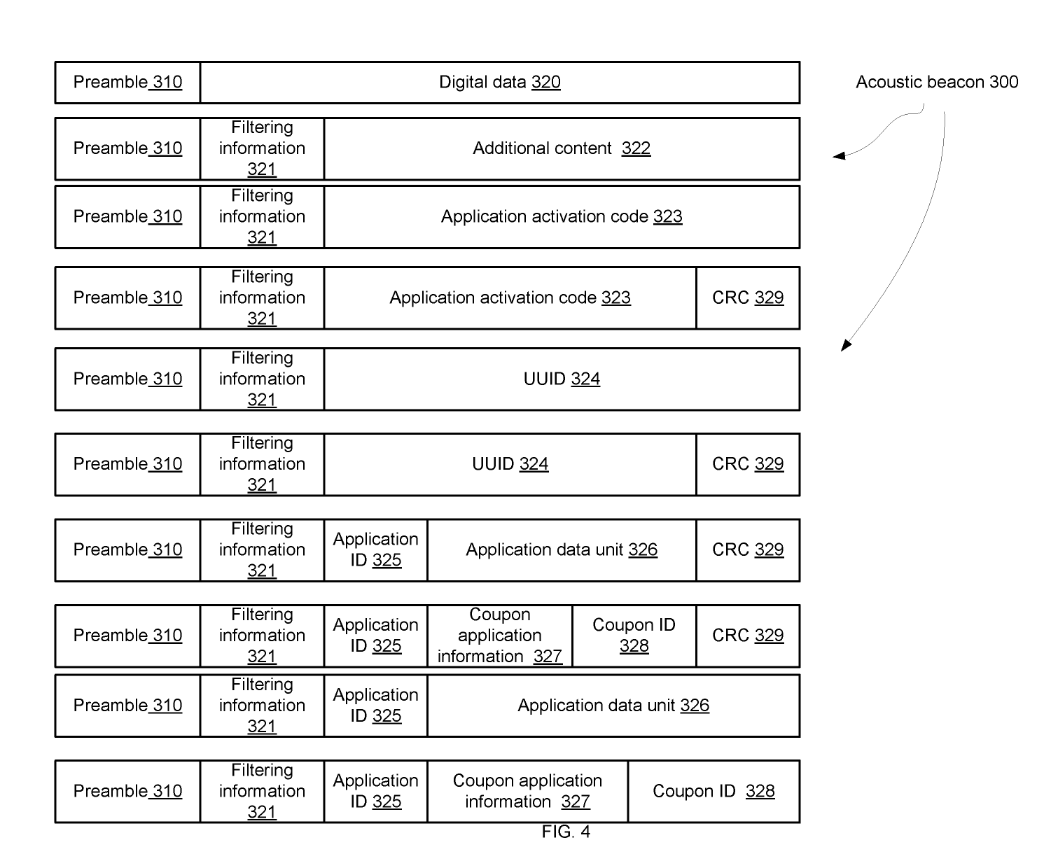

FIG. 4 provides examples of various acoustic beacons; and

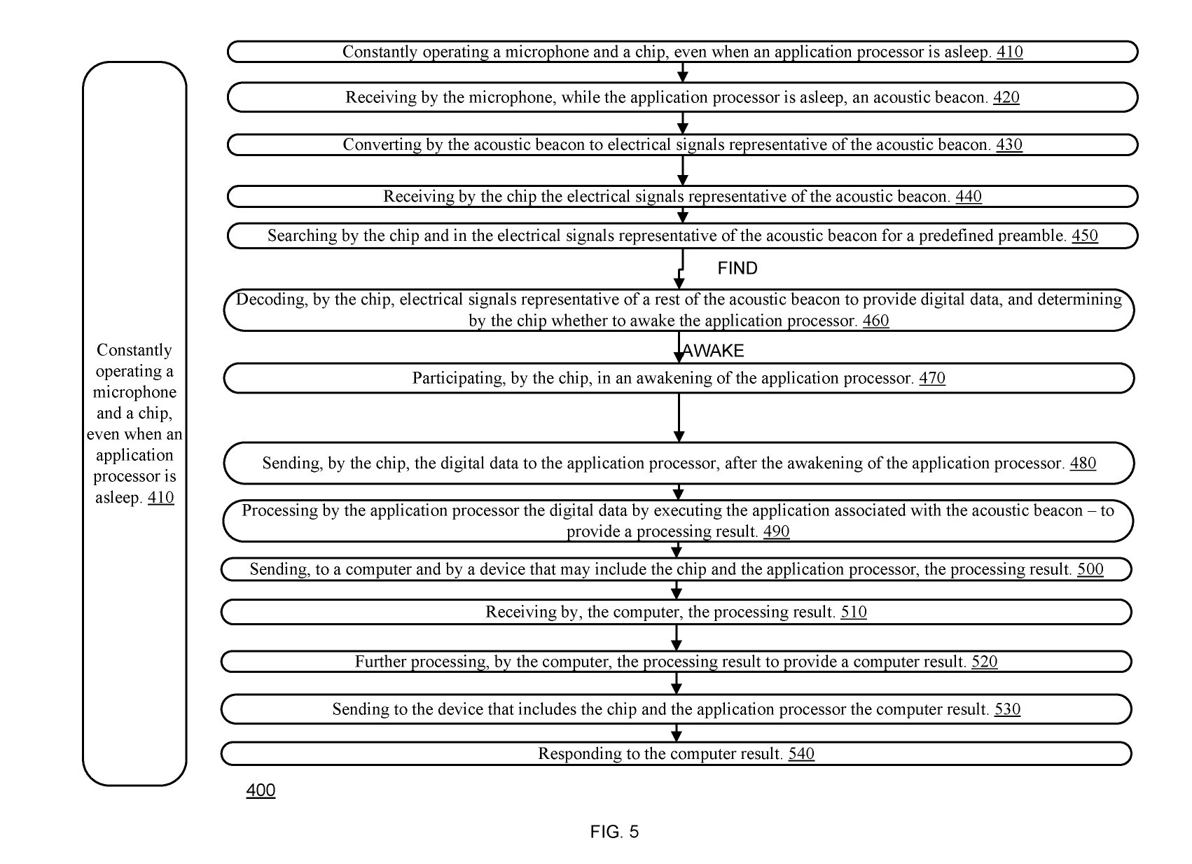

FIG. 5 is an example of a method.

### DETAILED DESCRIPTION OF THE INVENTION

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

In the following specification, there will be provides specific examples of embodiments. It will, however, be evident that various modifications and changes may be made therein without departing from the broader spirit and scope of the invention as set forth in the appended claims.

The term sonic data may be interpreted as digital data carried/conveyed by sound waves—acoustic energy, this is done by modulating the sound waves—either in the audible sonic spectrum or in the non-audible ultrasonic spectrum. The digitally modulated sound waves can be transduced by a regular speaker or by a special transducer.

The term ‘Acoustic beacon’ may mean a data conveying acoustic signal. The acoustic beacon may be transmitted over short range networks (few meters)—but this is not necessarily so.

The terms “acoustic beacon” and “electrical signals representative of an acoustic beacon” may be used in an interchangeable manner.

Acoustic beacon technology, which is used by retailers to ping promotional messages to customers' smartphones, is being incorporated into shopping malls. The acoustic beacons are used to ping shoppers with promotions and discounts and help retailers get a grasp on who's shopping and how often, and improve customer experience. And as the technology gains traction, more features could be on their way to digitizing the in-mall landscape.

There may be provided a device and a method that adds the capability to listen to ‘Sonic data’ (to be converted and processed to provide digital data) included in an acoustic beacon.

The device has a chip that is coupled to a microphone of the device. The chip is “Always on” and in response to a reception of a predefined acoustic beacon may invoke a device (such as a smart phone) to perform a predefined operation.

The acoustic beacon is detected by a chip (integrated circuit) of the device while the chip of the device runs in low power mode and looks for a preamble that includes a special pattern and once that preamble is detected the chip starts receiving the rest of the acoustic beacon, decodes it, and extracts the digital data.

During the decoding process and even while searching for acoustic beacons—the device may operate in a low power mode during which other components of the device (such as an application processor) may be shut down or be in idle mode (asleep).

The digital data conveyed in the acoustic beacon may be checked by the chip and at least some of the digital data may be compared to a predefined pattern in order to decide if to wake up the smart phone.

The device may detect the acoustic beacon on any acoustic range—including acoustic frequency bands that can be heard by humans and/or acoustic frequency bands that cannot be heard by humans.

The chip may apply any known demodulation and/or reception algorithm for detecting the acoustic beacon and/or extracting the digital data embedded in the acoustic beacon. For example—the chip may perform or ore more modulations out of DFSK, DQPSK, DBPSK, may include filters (such as IIR, and/or FIR), may perform clock recovery, carrier recovery, error correction, modulation and/or demodulation and the like.

Once the chip transfers the decoded data to the application processor then the application processor will launch the appropriate application that will use this digital data in order to perform its task.

Predefined preambles may be defined and/or selected in advance and made accessible to the chip by using, for example, an interaction with the user of the device (or by any other means)—in order to filter only the desired acoustic beacons that the smart phone owner desires to receive.

For example, see FIG. 1, a smart phone owner may stand in a grocery store near the Coca-Cola bottles stand. An acoustic beacon device is installed in this area and was preprogramed to send ‘Sonic data’ for Coca-Cola (210). The owner has on its smart phone an application published by this grocery store, the owner already set his phone to receive only acoustic beacons for this specific application in order not to be bothered by other acoustic beacons. The smart phone is in standby mode (screen is off) in the owner pocket. The acoustic beacon preamble was detected by the chip (214), the chip receives the rest of the acoustic beacon, compares (216) part of it in order to decide if this is the right acoustic beacon that should wake up the smart phone, wakes up (218) the phone which launches the application, data is conveyed (220) to the application which in turn sends it (222) to the internet cloud to be processed (224) by the grocery store servers. The server look for the data in its data base and in response sends back (226) to the owner application a coupon for a 10% discount on Coca-Cola bottles.

The chip and the microphone may be regarded as an always on acoustic modem.

The device may be configured to receive, after the activation of the application processor (within the acoustic beacon, outside the acoustic beacon) short messages, contact information, store promotions, advertisement and coupons, passwords, URL, Indoor navigation, and location.

The device may, in response to a detection of a predefined preamble, perform various operations such as payments, responding to reception, present information, and services to the user, perform automatic execution of applications and send a message to the sender of the acoustic beacon.

FIG. 2 illustrates various scenarios involving the device:
a. Chip 20 is in low power mode and the application processor is in sleep mode consuming very little power.
b. Acoustic beacon 50 is sent by a speaker 40, is received by microphone 10 that converts the acoustic beacon to electronic signals. The chip 20 stores the acoustic beacon in memory module 22 and may process it (decoding) to extract digital data.
c. If configured to do so the chip wakes up the application processor 30.
d. The application processor 30 pulls the digital data from the chip 20 and stores it at memory module 32 of the application processor.

FIG. 3 illustrates an example of device 60 such as but not limited a mobile phone.

Device 60 includes microphone 10, chip 20, application processor 30, power supply 72, transceiver 74, and a man machine interface 76 such as a display, a speaker and the like.

Power supply 72 may always supply power to the chip 20 and microphone 10 while application processor 30 may be enter a sleep mode and exit the sleep mode from time to time.

Transceiver 74 may communicate (directly or indirectly) with other devices and/or systems such as network 82 that in turn is coupled to computer 80.

The communication may be wired, wireless, short range communication, long range communication and the like.

FIG. 3 illustrates the man machine interface 70 as displaying a coupon 110.

Device 60 is illustrated as receiving acoustic beacons from acoustic beacon devices 101 and 102.

Computer 80 may be one or more servers.

Network 82 may be the Internet, a cloud computer environment or any network known in the art.

Chip 20 may include a low performance digital signal processor and small memory e.g. 128 KB. Chip 20 may run at low frequency e.g. 1 Mhz for the preamble detection while consuming 300 micro Watt after the detection of correct preamble the frequency is increased temporarily to a higher frequency e.g. 10 Mhz in order to process the rest of the beacon while consuming 1 miliWatt. The values of the low and high frequency and of the power consumptions are merely non-limiting examples—and the chip may increase its power consumption when decoding the remainder of the sonic beacon (after detecting the preamble).

A non-limiting example of the chip is the DBMx™ chip family of DSP group Ltd. of Herzliya, Israel. An application processor is a processor that may execute multiple applications. non-limiting example of an application processor is the Snapdragon™ family of Quallcomm™.

After the correct detection of the whole beacon the chip may invoke the Application processor 30 which usually includes powerful processor with multicores consuming several watts. The chip may convey the information received in the beacon to the application processor and return to its low power mode while continue listening to beacons

FIG. 4 illustrates various examples of acoustic beacon 300.

The acoustic beacon 300 may include a preamble 310 and digital data 320.

The digital data 320 is an example of a content of the acoustic beacon 300 that differs from the preamble.

The digital data 320 may include filtering information 321 and additional content 322.

The chip may process the additional content 322 and/or decide whether to wake the application processor based on the filtering information. For example—the value of the filtering information may indicate whether to wake up the application processor whenever the preamble indicates that the acoustic beacon is a relevant acoustic beacon or whether there are additional conditions (for example at least part of the additional content 322 shall also fulfill a predefined criterion).

The digital data 320 may or may not include error correction and/or error detection information such as CRC 329.

The additional content may be an application activation code 323 and/or a UUID 324.

The additional content 322 may include an application identifier (application ID) 325, a coupon identifier (coupon ID) 328 and/or one or more application data unit 326.

The application data unit may include coupon application information 327 and/or a coupon identifier (coupon ID) 328.

For example, the filtering information 321 currently has 3 values: 0000, 0001 and 0010.

When the value is 0000 the chip wakes up the AP and sends the UUID 324 to the AP to be sent to the cloud.

When the value is 0001 the chip wakes up the AP only if Application ID 325 is identical to pre-stored value in the chip.

When the value is 0010 the chip wakes up the AP only if Application ID code 325 is in the range of pre-stored values in the chip.

The application ID 325 has the number ID of the application to be invoked, every application should have a different number

The coupon application information 327 may include information for the application which was invoked according to the application ID 325, information could be the method a local coupon (as identified in the coupon ID 328) is presented, e.g. popup or sound or vibration or both. It could be also a request to the application to download from the cloud a specific coupon as specified in coupon ID 328.

The coupon ID 328 has the coupon number to be presented by the application, application can hold many coupons each allocated with a specific number, coupons can be downloaded to the application from the cloud or exist as art of the application

The acoustic beacon (or more accurately the electrical signals representative of the acoustic beacon) may be 164 bits long, the preamble may be 16 bits long, the filtering information may be 4 bits long, the additional content may be 144 bits long, the application activation code may be 128 bits long, the CRC may be 16 bits long, the application ID may be 32 bits long, the coupon application information may be 32 bits long and the coupon ID may be 64 bits long. Any other lengths may be used.

FIG. 5 illustrates an example of a method 400.

Method 400 may start by step 410 of constantly operating a microphone and a chip, even when an application processor is asleep.

In parallel to step 410, method 400 may include a sequence of steps 420, 430, 440 and additional steps.

Step 420 includes receiving by the microphone, while the application processor is asleep, an acoustic beacon.

Step 430 includes converting by the acoustic beacon to electrical signals representative of the acoustic beacon. The converting may occur when the acoustic beacon is within a human audible acoustic range and/or when the acoustic beacon is outside a human audible acoustic range.

The microphone is always on and constantly tries to detect acoustic beacons. On a sense step 430 is followed by step 420.

Steps 410, 420 and 430 may amount to constantly monitoring, by the chip, for the electrical signals that are representative of the acoustic beacon.

Step 440 includes receiving by the chip the electrical signals representative of the acoustic beacon.

Step 450 includes searching by the chip and in the electrical signals representative of the acoustic beacon for a predefined preamble. The predefined preamble is a preamble that has a value that fulfills a predefined condition—such as having a predefined value, being included within a predefined range of values. The predefined condition indicates that the acoustic beacon is relevant to the device (for example belongs to an application executed by a device that includes the chip and the application processor).

When detecting the predefined preamble then step 450 is followed by step 460 of decoding, by the chip, electrical signals representative of a rest of the acoustic beacon to provide digital data, and determining by the chip whether to awake the application processor.

The digital data may include at least one out of a message, contact information, a store promotion, an advertisement, a coupon, a password, a Uniform Resource Locator, indoor navigation metadata and location metadata.

Step 460 may include determining to awake the application processor based on the digital data.

When failing to detect the predefined preamble or when determining not to awake the application processor then step 460 may be followed by waiting to process electrical signals of another acoustic beacon.

When determining to awake the application processor then step 460 is followed by step 470 of participating, by the chip, in an awakening of the application processor.

Step 470 may be followed by step 480 of sending, by the chip, the digital data to the application processor, after the awakening of the application processor.

Step 480 may be followed by step 490 of processing by the application processor the digital data by executing the application associated with the acoustic beacon—to provide a processing result. The processing result may be the digital data, may include at least a part of the digital data, may differ from the digital data.

The processor may return to sleep after completing step 490 and/or under any other power saving rule.

Step 490 may be followed by step 500 of sending, to a computer and by a device that may include the chip and the application processor, the processing result.

Step 500 may be followed by step 510 of receiving by, the computer, the processing result.

Step 510 may be followed by step 520 of further processing, by the computer, the processing result to provide a computer result.

Step 520 may be followed by step 530 of sending to the device that includes the chip and the application processor the computer result.

Step 530 may be followed by step 540 of responding to the computer result. The responding may include, for example, displaying a coupon or information related to a service or product advertised by the acoustic beacon.

The chip (by executing step 460) and/or the application processor (by performing step 490) may determine whether the acoustic beacon is associated with a predefined application. The method may include ignoring the acoustic beacon when determining that the acoustic beacon is not associated with the predefined application.

Method 400 (and especially step 540) may include performing, by a device that may include the chip and the application processor, at least one operation out of performing a payment, presenting information to a user of the device, presenting services to the user, performing an automatic execution of the predefined and sending a message to a sender of the acoustic beacon.

Step 460 may include at least one of the following:
a. Determining to awake the application processor and to send the additional content to the application processor when the filtering information is of a first value and when detecting the predefine preamble.
b. Determining to awake the application processor and to send the additional content to the application processor when the filtering information is of a second value, when detecting the predefine preamble and when the additional content is of a predefined value.
c. Determining to awake the application processor and to send the additional content to the application processor when the filtering information is of a third value, when detecting the predefine preamble and when the additional content is within a predefined range of values.
d. Determining to awake the application processor and to send the additional content to the application processor in response to a value of the filtering information.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components Likewise, any two components so associated can also be viewed as being “operably connected,” or “operably coupled,” to each other to achieve the desired functionality.

However, other modifications, variations, and alternatives are also possible. The specifications and drawings are, accordingly, to be regarded in an illustrative rather than in a restrictive sense.

The word “comprising” does not exclude the presence of other elements or steps then those listed in a claim. It is understood that the terms so used are interchangeable under appropriate circumstances such that the embodiments of the invention described herein are, for example, capable of operation in other orientations than those illustrated or otherwise described herein.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe.

Thus, these terms are not necessarily intended to indicate temporal or other prioritization of such elements. The mere fact that certain measures are recited in mutually different claims does not indicate that a combination of these measures cannot be used to advantage.

We claim:

1. A method for sonic acoustic beacon processing, the method comprises:
constantly operating a microphone and a chip, even when an application processor is asleep;
receiving by the microphone, while the application processor is asleep, an acoustic beacon;
converting by the acoustic beacon to electrical signals representative of the acoustic beacon;
receiving by the chip the electrical signals representative of the acoustic beacon;
searching, by the chip and in the electrical signals representative of the acoustic beacon for a predefined preamble;
when detecting the predefined preamble then decoding, by the chip, electrical signals representative of a rest of the acoustic beacon to provide digital data, and determining by the chip whether to awake the application processor;
when determining to awake the application processor then participating, by the chip, in an awakening of the application processor; and
sending, by the chip, the digital data to the application processor, after the awakening of the application processor.

2. The method according to claim 1 comprising constantly monitoring by the chip for the electrical signals that are representative of the acoustic beacon.

3. The method according to claim 1 comprising determining to awake the application processor based on the digital data.

4. The method according to claim 1 wherein the digital data comprises filtering information and additional content; wherein the method comprises determining to awake the application processor and to send the additional content to the application processor when the filtering information is of a first value and when detecting the predefine preamble.

5. The method according to claim 4 wherein the additional content is an application activation code or a universally unique identifier.

6. The method according to claim 1 wherein the digital data comprises filtering information and additional content; wherein the method comprises determining to awake the application processor and to send the additional content to the application processor when the filtering information is of a second value, when detecting the predefine preamble and when the additional content is of a predefined value.

7. The method according to claim 6 wherein the additional content is an application activation code or a universally unique identifier.

8. The method according to claim 1 wherein the digital data comprises filtering information and additional content; wherein the method comprises determining to awake the application processor and to send the additional content to the application processor when the filtering information is of a third value, when detecting the predefine preamble and when the additional content is within a predefined range of values.

9. The method according to claim 8 wherein the additional content is an application activation code or a universally unique identifier.

10. The method according to claim 1 wherein the digital data comprises filtering information and additional content; wherein the additional content comprises (a) an application identifier that identifies an application to be executed by the application processor, and (b) at least one application data unit to be processed by the application processor when the application processor executes the application; wherein the method comprises determining to awake the application processor and to send the additional content to the application processor in response to a value of the filtering information.

11. The method according to claim 10 wherein the at least one application data unit comprises coupon appearance information and a coupon identifier.

12. The method according to claim 1 comprising sending, to a computer and by a device that comprises the chip and the application processor, the digital data; and
receiving from the computer a response to the digital data.

13. The method according to claim 1 comprising determining by at least one of the chip and the application processor whether the acoustic beacon is associated with a predefined application; transmitting at least a part of the digital data to a computer when the acoustic beacon is associated with the predefined application; receiving from the computer coupon information and presenting to a user of the device the coupon information.

14. The method according to claim 13 comprising ignoring the acoustic beacon when determining that the acoustic beacon is not associated with the predefined application.

15. The method according to claim 1 wherein comprising converting the acoustic beacon when the acoustic beacon is within a human audible acoustic range.

16. The method according to claim 1 wherein comprising converting the acoustic beacon when the acoustic beacon is outside a human audible acoustic range.

17. The method according to claim 1 comprising determining by at least one of the chip and the application processor whether the acoustic beacon is associated with a predefined application; and performing, by a device that comprises the chip and the application processor, at least one operation out of performing a payment, presenting information to a user of the device, presenting services to the user, performing an automatic execution of the predefined and sending a message to a sender of the acoustic beacon.

18. The method according to claim 1 wherein the digital data comprises at least one out of a message, contact information, a store promotion, an advertisement, a coupon, a password, a Uniform Resource Locator, indoor navigation metadata and location metadata.

19. A device for sonic acoustic beacon processing, the device comprises a microphone, a chip and an application processor; wherein the microphone is configured to (a) receive, while the application processor is asleep, an acoustic beacon and (b) convert the acoustic beacon to electrical signals representative of the acoustic beacon;
wherein the chip is configured to receive the electrical signals representative of the acoustic beacon and to search for a predefined preamble; wherein when detecting the predefined preamble the chip is configured to (i) decode electrical signals representative of a rest of the acoustic beacon to provide digital data; and (ii) determine whether to awake the application processor; and wherein when determining to awake the application processor the chip is configured to participate in an awakening of the application processor and to send the digital data to the application processor, after the awakening of the application processor.

20. The device according to claim 19 comprising a power supply that is configured to constantly power the microphone and the chip even when the application processor is asleep.

21. A computer program product that stores instructions that once executed by a device that comprises a microphone, a chip and an application processor causes the device to perform the steps of constantly operating a microphone and a chip, even when an application processor is asleep; receiving by the microphone, while the application processor is asleep, an acoustic beacon; converting by the acoustic beacon to electrical signals representative of the acoustic beacon; receiving by the chip the electrical signals representative of the acoustic beacon; searching, by the chip and in the electrical signals representative of the acoustic beacon for a predefined preamble; when detecting the predefined preamble then decoding, by the chip, electrical signals representative of a rest of the acoustic beacon to provide digital data, and determining by the chip whether to awake the application processor; when determining to awake the application processor then participating, by the chip, in an awakening of the application processor; and sending, by the chip, the digital data to the application processor, after the awakening of the application processor.
